(19) United States
(12) Patent Application Publication
(10) Pub. No.: US 2024/0215539 A1
(43) Pub. Date: Jul. 4, 2024

(54) ANIMAL CLEANING SYSTEM

(71) Applicant: Greg Hines, Vernon, AZ (US)

(72) Inventor: Greg Hines, Vernon, AZ (US)

(21) Appl. No.: 18/090,957

(22) Filed: Dec. 29, 2022

(51) Int. Cl. A01K 13/00

(52) U.S. Cl. CPC A01K 13/004; A01K 13/001; A01K 13/003

(57) ABSTRACT

An animal cleaning system removably connected to at least a portion of a pet door, the animal cleaning system including at least one main body to extend from a top portion of the pet door to a bottom portion of the pet door, a tubular spring shell disposed on at least a portion of the at least one main body to spring bias the at least one main body to remain draped over the pet door, and a shell cover disposed on at least a portion of the tubular spring shell to clean the animal moving through the pet door in response to contact with a portion of a body of the animal.

### BACKGROUND

### 1. Field

The present general inventive concept relates generally to cleaning, and particularly, to an animal cleaning system.

### 2. Description of the Related Art

Pets are popular companions for people providing emotional comfort and/or entertainment. However, owning a pet requires care of the pet, such as feeding, training, and grooming.

Most owners of pets will struggle with hair being spread around a house and the many challenges to performing grooming care. Unfortunately, excess hair and debris from pets often travels all around the house, which can be difficult to collect and/or clean from varying surfaces. Thus, grooming is a highly essential task to help manage excess hair and reduce shedding. However, an owner of the pet will have to hold the pet while using a brush and/or a sponge to groom the pet.

Therefore, there is a need for an animal cleaning system that cleans the pet while it enters the house to prevent spread of debris and maintain cleanliness.

### SUMMARY

The present general inventive concept provides an animal cleaning system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an animal cleaning system removably connected to at least a portion of a pet door, the animal cleaning system including at least one main body to extend from a top portion of the pet door to a bottom portion of the pet door, a tubular spring shell disposed on at least a portion of the at least one main body to spring bias the at least one main body to remain draped over the pet door, and a shell cover disposed on at least a portion of the tubular spring shell to clean the animal moving through the pet door in response to contact with a portion of a body of the animal.

The shell cover may be constructed of microfiber.

The shell cover may be coated with an insect repellent.

The animal cleaning system may further include a door frame fastener disposed on at least a portion of the at least one main body to removably connect the at least one main body to the pet door.

The animal cleaning system may further include at least one cleaning strip suspended from the pet door to clean the animal moving through the pet door in response to contact with a portion of a body of the animal, and a strip fastener disposed on at least a portion of the at least one cleaning strip to removably connect the at least one cleaning strip to the pet door.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front perspective view of an animal cleaning system, according to an exemplary embodiment of the present general inventive concept;

FIG. 2 illustrates a sectional view of the animal cleaning system, according to an exemplary embodiment of the present general inventive concept; and

FIG. 3 illustrates a front perspective view of an animal cleaning system, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Animal Cleaning System 100
Main Body 110
Tubular Spring Shell 120
Shell Cover 130
Door Frame Fastener 140
Weighted Balls 150
Animal Cleaning System 200
Cleaning Strip 210
Strip Fastener 220

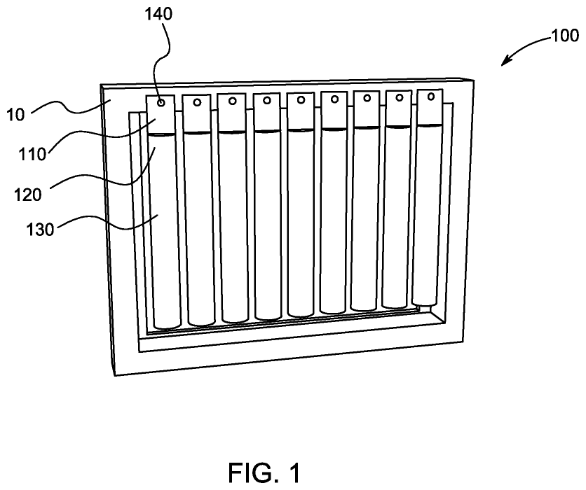

FIG. 1 illustrates a front perspective view of an animal cleaning system 100, according to an exemplary embodiment of the present general inventive concept.

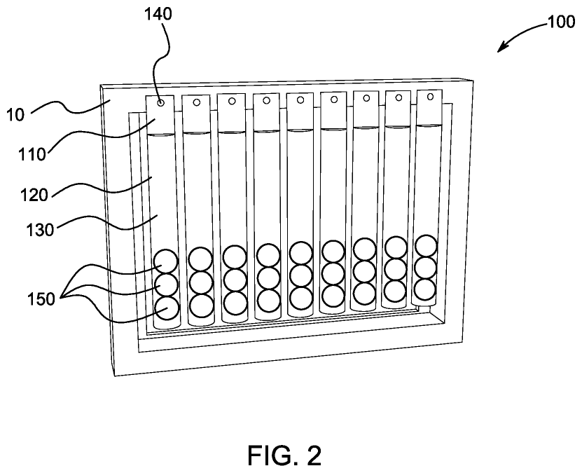

FIG. 2 illustrates a sectional view of the animal cleaning system 100, according to an exemplary embodiment of the present general inventive concept.

The animal cleaning system 100 may be constructed from at least one of rubber, cloth, metal, plastic, and wood, etc., but is not limited thereto.

Referring to FIGS. 1 and 2, the animal cleaning system 100 may include at least one main body 110, a tubular spring shell 120, a shell cover 130, a door frame fastener 140, and a plurality of weighted balls 150, but is not limited thereto.

The at least one main body 110 may have an elongate shape. Moreover, the at least one main body 110 may have a predetermined size based on a size of a pet door 10. More specifically, a size (e.g., length, width) of the at least one main body 110 may extend from a top portion of the pet door 10 to a bottom portion of the pet door 10.

The tubular spring shell 120 may include a coiled spring, but is not limited thereto.

The tubular spring shell 120 may be disposed on at least a portion of the at least one main body 110. Moreover, the tubular spring shell 120 may extend at least a portion of a length of the at least one main body 110. The tubular spring shell 120 may move the at least one main body 110 to an original position after being moved by an animal moving through the pet door 10. In other words, the tubular spring shell 120 may spring bias the at least one main body 110 to remain draped (e.g., suspended over the pet door 10 toward a ground surface) over the pet door 10.

The shell cover 130 may be constructed of microfiber and rubber, but is not limited thereto.

The shell cover 130 may be disposed on at least a portion of a perimeter of the tubular spring shell 120. More specifically, the shell cover 130 may surround and/or cover an entirety of the tubular spring shell 120. Additionally, the shell cover 130 may facilitate cleaning of the animal moving through the pet door 10 in response to contact with a portion of a body of the animal. As such, the shell cover 130 may remove and/or clean the animal, such that the shell cover 130 may remove mud, dirt, leaves, and/or excess hair disposed on the animal. Thus, the shell cover 130 may clean the animal without requiring active participation by an owner.

Furthermore, the shell cover 130 may be coated with an insect repellent, such as tick and/or flea repellant to remove insects from the animal.

The at least one main body 110, the tubular spring shell 120, and/or the shell cover 130 may be removed from the pet door 10 to be cleaned by hand and/or in a washing machine. As such, the at least one main body 110, the tubular spring shell 120, and/or the shell cover 130 may be cleaned for reuse.

The door frame fastener 140 may include an aperture (e.g., to be hanged by a hook on the pet door 10), a clamp, a clip, a clasp, a screw, a nail, a bolt, a washer, a nut, a magnet, an adhesive (e.g., tape, glue), and/or any combination thereof, but is not limited thereto.

The door frame fastener 140 may be disposed on at least a portion of the at least one main body 110. The door frame fastener 140 may removably connect the at least one main body 110 to the pet door 10, such that the at least one main body 110 may be suspended from the pet door 10.

Each of the plurality of weighted balls 150 may include a weight, but is not limited thereto.

Each of the plurality of weighted balls 150 may have a predetermined weight (e.g., one pounds, two pounds, three pounds) based on preventing the at least one main body 110 from moving and/or falling off the pet door 10. The plurality of weighted balls 150 may be removably disposed within at least a portion of the tubular spring shell 120 and/or the shell cover 130. The plurality of weighted balls 150 may stabilize the at least one main body 110, the tubular spring shell 120, and/or the shell cover 130 while disposed on the pet door 10. For example, the plurality of weighted balls 150 may keep the at least one main body 110, the tubular spring shell 120, and/or the shell cover 130 draped over the pet door 10 after the animal moves through the pet door 10.

Therefore, the animal cleaning system 100 may clean the animal in response to movement of the animal through the pet door 10. Also, the animal cleaning system 100 may prevent spread of dirt and/or debris within a house.

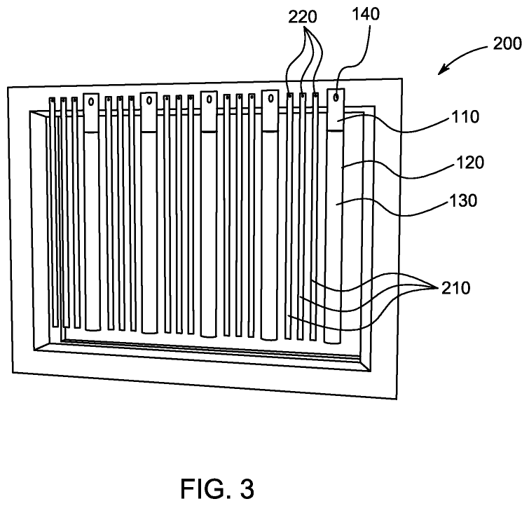

FIG. 3 illustrates a front perspective view of an animal cleaning system 200, according to another exemplary embodiment of the present general inventive concept.

The animal cleaning system 200 may be constructed from at least one of rubber, cloth, metal, plastic, and wood, etc., but is not limited thereto.

The animal cleaning system 200 may include at least one main body 110, a tubular spring shell 120, a shell cover 130, a door frame fastener 140, a plurality of weighted balls 150, at least one cleaning strip 210, and a strip fastener 220, but is not limited thereto.

The animal cleaning system 200 is similar to the animal cleaning system 100 described above. Referring to FIG. 3, the animal cleaning system 200 includes components similar to the animal cleaning system 100. As such, for sake of brevity, the description of similar components has been described above.

The at least one cleaning strip 210 may be constructed of rubber, but is not limited thereto.

The at least one cleaning strip 210 may have an elongate and/or rectangular shape. However, the at least one cleaning strip 210 may be cylindrical, triangular, pentagonal, hexagonal, heptagonal, octagonal, or any other shape known to one of ordinary skill in the art. Also, the at least one cleaning strip 210 may have a predetermined size based on the size of the pet door 10. More specifically, a size (e.g., length, width) of the at least one cleaning strip 210 may extend from the top portion of the pet door 10 to the bottom portion of the pet door 10. The size of the at least one cleaning strip 210 may be smaller than the size of the at least one main body 110.

The at least one cleaning strip 210 may facilitate cleaning of the animal moving through the pet door 10 in response to contact with a portion of a body of the animal. As such, the at least one cleaning strip 210 may remove and/or clean the animal, such that the at least one cleaning strip 210 may remove mud, dirt, leaves, and/or excess hair disposed on the animal. Thus, the at least one cleaning strip 210 may clean the animal without requiring active participation by the owner.

The strip fastener 220 may include an aperture (e.g., to be hanged by a hook on the pet door 10), a clamp, a clip, a clasp, a screw, a nail, a bolt, a washer, a nut, a magnet, an adhesive (e.g., tape, glue), and/or any combination thereof, but is not limited thereto.

The strip fastener 220 may be disposed on at least a portion of the at least one cleaning strip 210. The strip fastener 220 may removably connect the at least one cleaning strip 210 to the pet door 10, such that the at least one cleaning strip 210 may be suspended from the pet door 10.

Therefore, the animal cleaning system 200 may clean the animal in response to movement of the animal through the pet door 10. Also, the animal cleaning system 200 may prevent spread of dirt and/or debris within a house.

The present general inventive concept may include an animal cleaning system 100 removably connected to at least a portion of a pet door 10, the animal cleaning system 100 including at least one main body 110 to extend from a top portion of the pet door 10 to a bottom portion of the pet door 10, a tubular spring shell 120 disposed on at least a portion of the at least one main body 110 to spring bias the at least one main body 110 to remain draped over the pet door 10, and a shell cover 130 disposed on at least a portion of the tubular spring shell 120 to clean the animal moving through the pet door 10 in response to contact with a portion of a body of the animal.

The shell cover 130 may be constructed of microfiber.

The shell cover 130 may be coated with an insect repellent.

The animal cleaning system 100 may further include a door frame fastener 140 disposed on at least a portion of the at least one main body 110 to removably connect the at least one main body 110 to the pet door 10.

The animal cleaning system 200 may further include at least one cleaning strip 210 suspended from the pet door 10 to clean the animal moving through the pet door 10 in response to contact with a portion of a body of the animal, and a strip fastener 220 disposed on at least a portion of the at least one cleaning strip 210 to removably connect the at least one cleaning strip 210 to the pet door 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An animal cleaning system removably connected to at least a portion of a pet door, the animal cleaning system comprising:
at least one main body to extend from a top portion of the pet door to a bottom portion of the pet door;
a tubular spring shell disposed on at least a portion of the at least one main body to spring bias the at least one main body to remain draped over the pet door; and
a shell cover disposed on at least a portion of the tubular spring shell to clean the animal moving through the pet door in response to contact with a portion of a body of the animal.

2. The animal cleaning system of claim 1, wherein the shell cover is constructed of microfiber.

3. The animal cleaning system of claim 1, wherein the shell cover is coated with an insect repellent.

4. The animal cleaning system of claim 1, further comprising:
a door frame fastener disposed on at least a portion of the at least one main body to removably connect the at least one main body to the pet door.

5. The animal cleaning system of claim 1, further comprising:
at least one cleaning strip suspended from the pet door to clean the animal moving through the pet door in response to contact with a portion of a body of the animal; and
a strip fastener disposed on at least a portion of the at least one cleaning strip to removably connect the at least one cleaning strip to the pet door.
